(19) United States
(12) Patent Application Publication
(10) Pub. No.: US 2012/0080545 A1
(43) Pub. Date: Apr. 5, 2012

(54) TRUSS-TYPE SUPPORT SYSTEM FOR IRRIGATION SYSTEMS

(75) Inventor: Thomas J. Korus, Lindsay, NE (US)

(73) Assignee: LINDSAY CORPORATION, Omaha, NE (US)

(21) Appl. No.: 12/897,278

(22) Filed: Oct. 4, 2010

(51) Int. Cl. B05B 3/00

(52) U.S. Cl. 239/723

(57) ABSTRACT

A truss-type support system for a water-carrying conduit of an irrigation system includes a plurality of elongated truss braces and at least one truss rod for interconnecting the truss braces. The truss braces each have a pair of interconnected legs separated by an angle of approximately 40°-70°.

### BACKGROUND

Mechanized irrigation systems are commonly used to irrigate crops. Two common types of such systems are center pivot and lateral move irrigation systems, both of which include a number of interconnected spans supported by mobile towers. Each span includes a water-carrying conduit and a number of sprinkler heads, spray guns, drop nozzles or other fluid-emitting devices spaced along the length of the conduit.

The water-carrying conduits of the spans are typically under compressive loading between the mobile towers and are held in such condition by a truss-type support system. Each truss-type support system is typically positioned underneath its conduit and maintains the same in a slightly upwardly bowed condition when the conduit is empty and supports the weight of the conduit when it is filled with water. Conventionally, the truss-type support systems are constructed of a series of braces that are attached to the conduits and interconnected by elongated truss rod assemblies. Because the water-carrying conduits are extremely heavy when filled with water or other fluids, the truss-type support systems must be sufficiently strong and rigid to support the weight.

### SUMMARY

The braces in conventional irrigation systems are typically formed of L-shaped angle iron with legs that are separated by 90°. A cross-sectional view of such a brace is shown in FIGS. 3 and 4 along with X, Y, Z axes lines. When the truss-type support systems formed from these braces are subjected to compressive loads exerted by the weight of the water-filled conduits, the braces tend to bend away from their mounting surfaces in a direction denoted by the line B and about a Z-axis as depicted in FIG. 4. This causes the mid-sections of the braces to flatten-out (the legs become separated by an angle approaching 180°) and to bow outwardly, thus allowing the water-filled conduit to droop or bow downwardly.

Applicant has discovered that the truss-type support systems can withstand higher compressive loads without excessive bending when the braces are formed with angle iron with legs separated by an angle less than 90°. When a truss-type support system is constructed in this manner, the braces tend to bend less than braces formed from 90° angle iron when subjected to the same load.

Embodiments of the present invention take advantage of this discovery by providing improved truss-type support systems for water-carrying conduits of irrigation systems. An exemplary truss-type support system comprises a plurality of elongated truss braces having first ends attached to the water-carrying conduit and at least one truss rod for interconnecting second ends of the truss braces. In one embodiment, the truss braces each have a pair of interconnected legs separated by an angle of approximately 40°-70°. In another embodiment, the truss braces have legs separated by approximately 60°.

Applicant has discovered that a truss-type support system constructed in this manner is stronger than conventional truss-type supports and thus permits the truss braces to be made of thinner metal and/or the truss-type support to be fabricated with fewer truss braces. In either event, this allows the truss-type support system, and thus the overall irrigation system, to be made of less materials and hence be lighter and less costly to manufacture and operate.

This summary is provided to introduce a selection of concepts in a simplified form that are further described in the detailed description below. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWINGS

Embodiments of the present invention are described in detail below with reference to the attached drawing figures, wherein:

FIG. 1 is a fragmentary, perspective, somewhat schematic view of an irrigation system on which embodiments of the present invention may be employed;

FIG. 2 is an enlarged, fragmentary elevational view of one side of the irrigation system, with part of the truss-type support system broken out for clarity;

FIG. 3 is a cross-sectional view of a brace of a prior art truss-type support system shown along with X-Y-Z axes;

FIG. 4 is a cross-sectional view of the prior art brace of FIG. 3 shown attached to a mounting surface and depicting a bending direction of the brace when it is subjected to a compressive load;

FIG. 5 is a cross-sectional view of a truss-type support system brace of the present invention shown along with X-Y-Z axes;

FIG. 6 is a cross-sectional view of the brace of FIG. 3 shown attached to a mounting surface and depicting a bending direction of the brace when it is subjected to a compressive load;

FIG. 7 is an enlarged, fragmentary perspective view of portions of the truss-type support system shown in FIG. 2;

FIG. 8 is an enlarged, fragmentary perspective view of other portions of the truss-type support system shown in FIG. 2; and

FIG. 9 is an enlarged, fragmentary perspective view of portions of the truss-type support system shown in FIG. 7, the view similar to that of FIG. 7, but from the opposite vantage point.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of embodiments of the invention references the accompanying drawings. The embodiments are intended to describe aspects of the invention in sufficient detail to enable those skilled in the art to practice the invention. Other embodiments can be utilized and changes can be made without departing from the scope of the claims. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

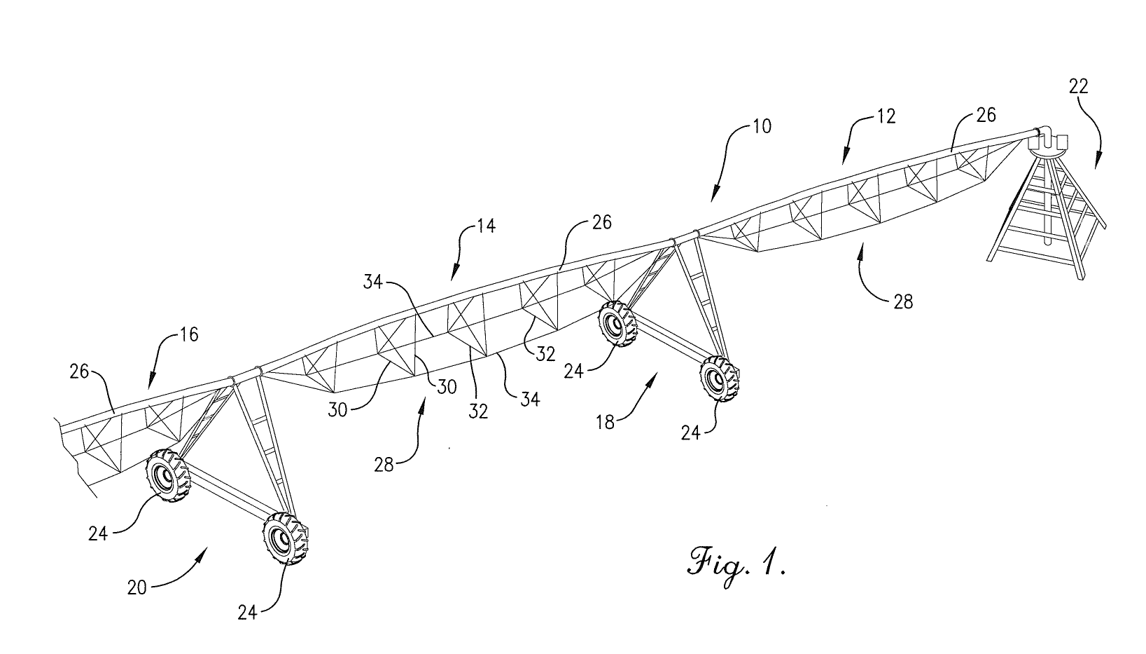

A mechanized irrigation system 10 selected for purposes of describing aspects of the present invention is shown in FIG. 1. The illustrated irrigation system 10 is a center pivot irrigation system that includes a number of interconnected spans 12, 14, 16 supported by mobile towers 18, 20. The innermost span 12 is pivotally connected to a stationary center pivot tower 22 having access to a source of fluid such as a well, water tank, water pipe, etc. While only three spans and two mobile towers are illustrated, it will be appreciated by those of ordinary skill in the art that the irrigation system 10 may include any number of such spans and mobile towers and that the number of spans and towers shown is not intended to confine the scope of the present invention. Further, the principles of the present invention are not limited to use with a center pivot irrigation system, but may also be employed with other types of irrigation systems, including, for example, lateral move systems and other types that do not employ a fixed center pivot tower.

As is well known, the mobile towers 18, 20 include wheels 24 driven by suitable drive motors. Generally, steerable wheels on an outermost mobile tower are pivoted about an upright axis by a suitable steering motor associated with the outer mobile tower so that the spans 12, 14, 16 of the irrigation system follow a predetermined track presented by a buried cable, a GPS system, or the like. As is also well known, the drive motors for the mobile towers 18, 20 are controlled by a suitable safety system such that they may be slowed, or completely shut down, in the event of the detection of an adverse circumstance.

Each of the spans 12, 14, 16 and additional spans not illustrated broadly includes a water-carrying conduit 26 and a truss-type support system 28 for supporting the conduit between the mobile towers 18, 20 and the center pivot tower 22. The conduit 26 of each span is connected in fluid flow communication with all other conduits of the irrigation system to provide water to numerous sprinklers or other water emitting devices (not shown) in order to irrigate a field. The conduits 26 may be of any size and constructed of any suitable materials. For example, in one embodiment, the conduits are approximately 6⅝″ in outside diameter and formed of galvanized steel. To accommodate the weight of the water in the conduits, each conduit is slightly arched or bowed upwardly when empty and is supported in such condition by its truss-type support system as illustrated in FIG. 1.

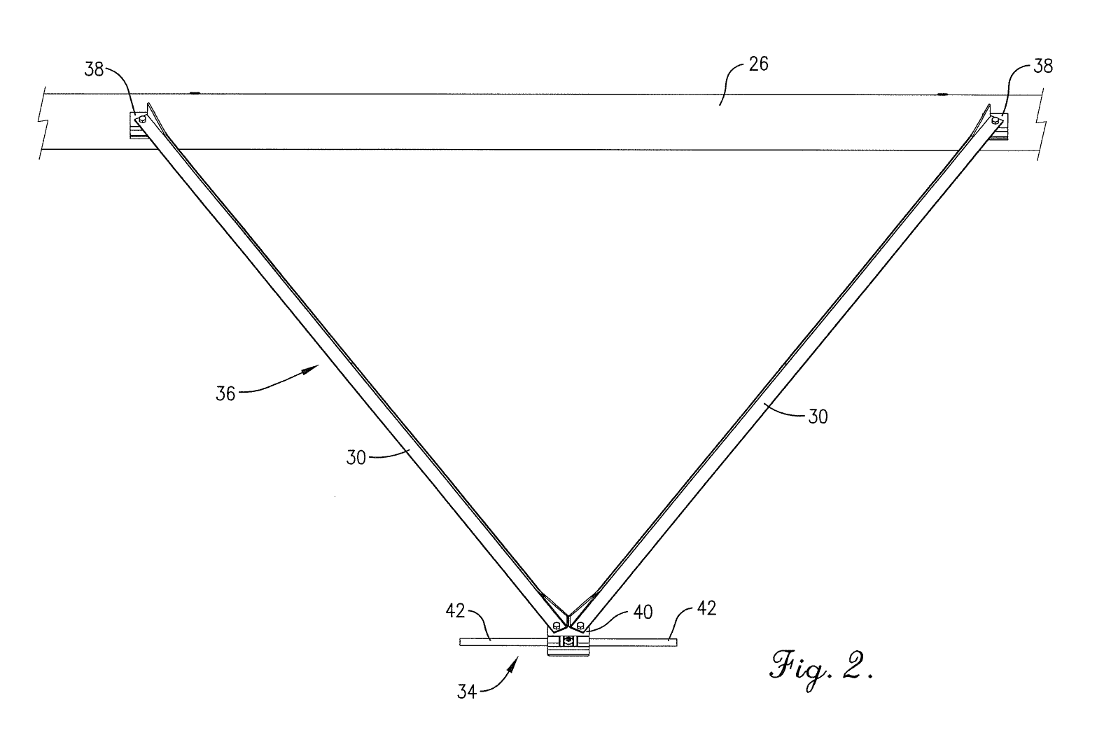

Each truss-type support system 28 is positioned below its respective conduit 26 and includes a plurality of elongated truss braces 30, a plurality of transverse braces 32, and a pair of truss rod assemblies 34. As best illustrated in FIG. 2, the braces 30 may be arranged in pairs and oriented to form a plurality of V-shaped supports 36. The V-shaped supports 36 are downwardly and outwardly angled and positioned on opposite sides of the conduit 26 with opposing pairs of V-shaped supports connected at their apexes by the transverse braces 32.

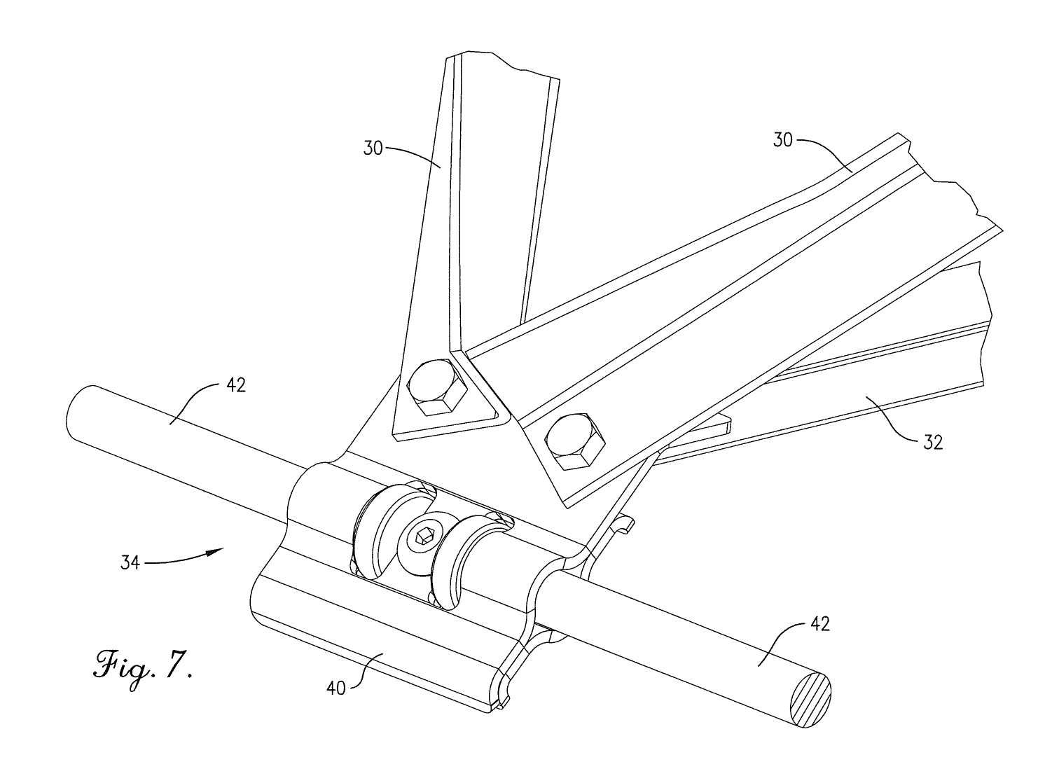

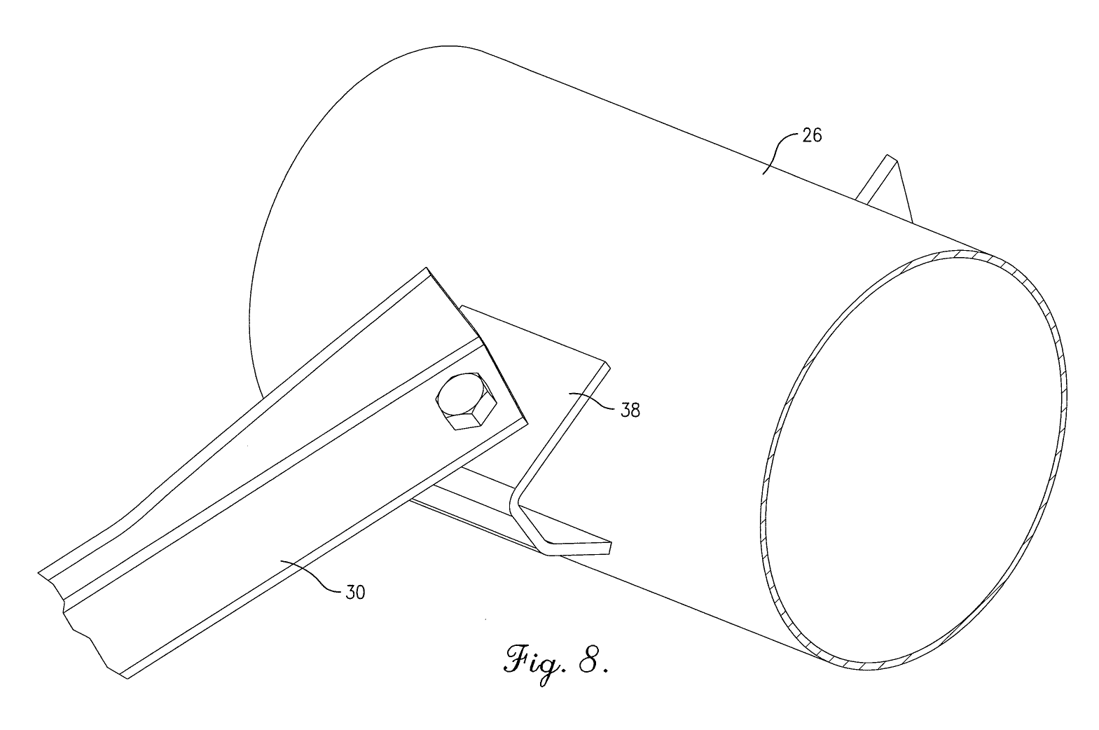

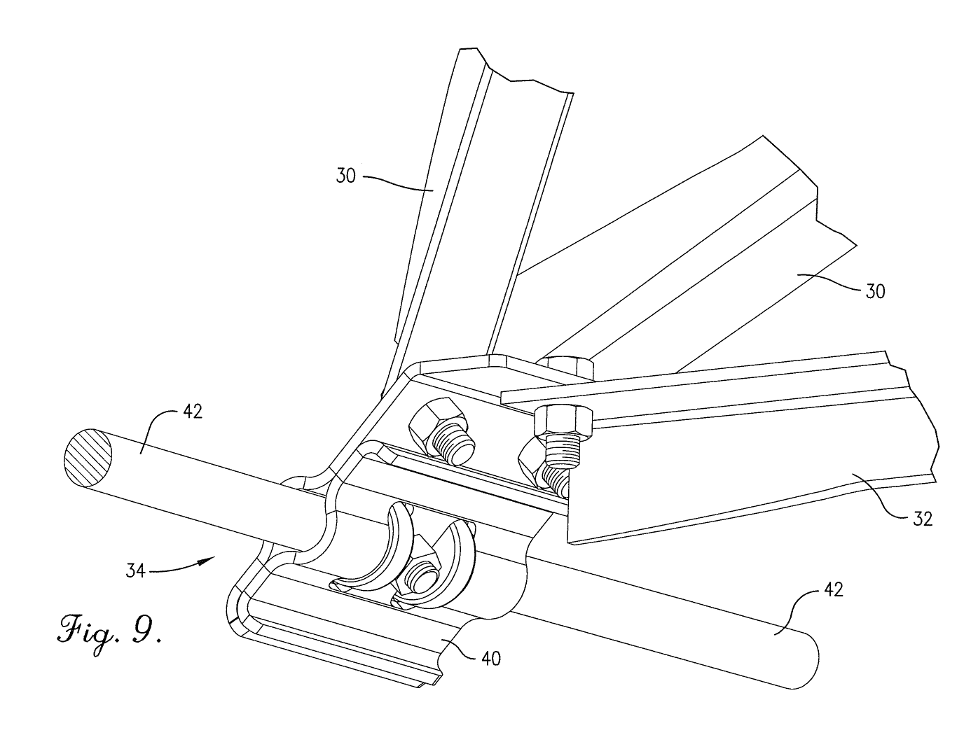

As best illustrated in FIGS. 2, 7, 8, and 9, the upper ends of the braces 30 are bolted or otherwise connected to brackets 38 or connectors fixed to the conduit 26. The lower and outer ends of the braces are secured to a coupling assembly 40 by bolts and corresponding nuts. In a similar fashion, each transverse brace 32 is affixed to its coupling assembly 40 by a bolt and a corresponding nut.

The truss rod assemblies 34 are positioned on opposite sides of the conduits 26 and interconnect successive V-shaped supports 36 at their apexes. The ends of each truss rod assembly 34 connect to terminal portions of its conduit 26.

Each truss rod assembly 34 includes a series of individual truss rods 42 that are disposed in generally axial alignment with one another and interconnected by the coupling assemblies 40 at the apexes of the V-shaped supports. As best illustrated in FIGS. 2, 7, and 9, each truss rod 42 includes a shaft section and enlarged cylindrical heads at its opposite ends. The enlarged heads fit into and are securely held by the coupling assemblies 40. Additional details of the truss rod assemblies 34 and coupling assemblies 40 are described and illustrated in more detail in U.S. Patent Publication No. 2008/0313992, which is hereby incorporated into the present application in its entirety by reference.

The spans 12, 14, 16 of the irrigation system may include any number of braces 30, transverse braces 32, and truss rod assemblies 34, largely depending upon the length of the span and hence the length and weight of the water-carrying conduit 26. In one embodiment, each span is approximately 180′ long and includes five V-braces 36 (with ten total braces 30) on each side of the conduit; five transverse braces 32; and two truss road assemblies 34, one on each side of the conduit. The length of the truss braces 30 varies depending upon their location along the length of the span. In one embodiment, the braces 30 in the first pair of V-braces (when counted from left to right in FIG. 2) are 63½″ long; the braces in the second pair of V-braces are 81¼″ long; the braces in the third pair of V-braces are 97¾″ long; the braces in the fourth pair of V-braces are 101¾″ long; and the braces in the fifth pair of V-braces are 101¾″ long.

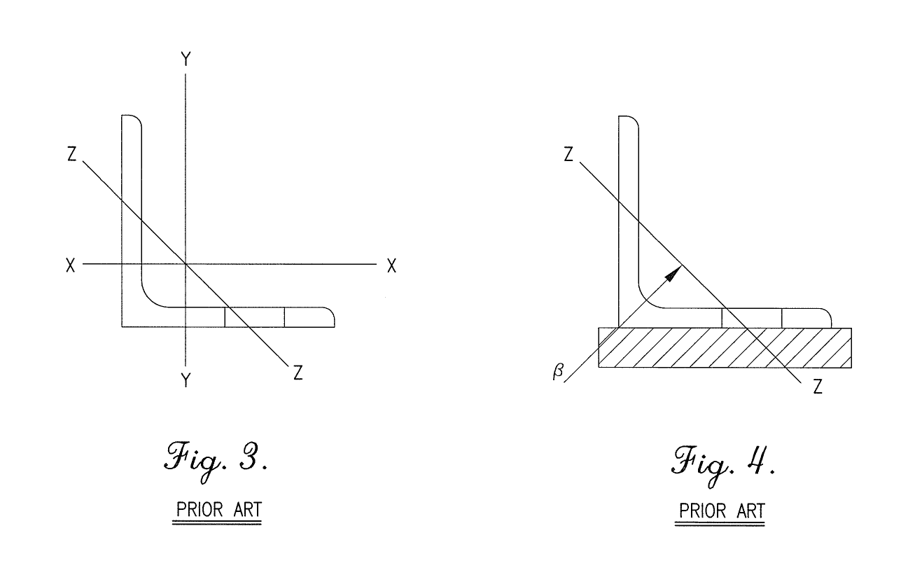

In accordance with one important aspect of the invention, the braces 30 are constructed and configured to increase the truss-type support systems' ability to support compressive loads exerted by the weight of the water-filled conduits 26. The braces in conventional irrigation systems are typically formed of L-shaped angle iron with legs that are separated by an angle of approximately 90° as shown in FIGS. 3 and 4. When the truss-type support systems formed from these braces are subjected to compressive loads exerted by the weight of the water-filled conduits, the braces tend to bend away from their mounting surfaces in a direction denoted by the line B and about a Z-axis as depicted in FIG. 4. This causes the mid-sections of the braces to flatten-out (the legs become separated by an angle approaching 180°) and to bow outwardly, thus allowing the water-filled conduits to droop downwardly between the mobile towers 18, 20.

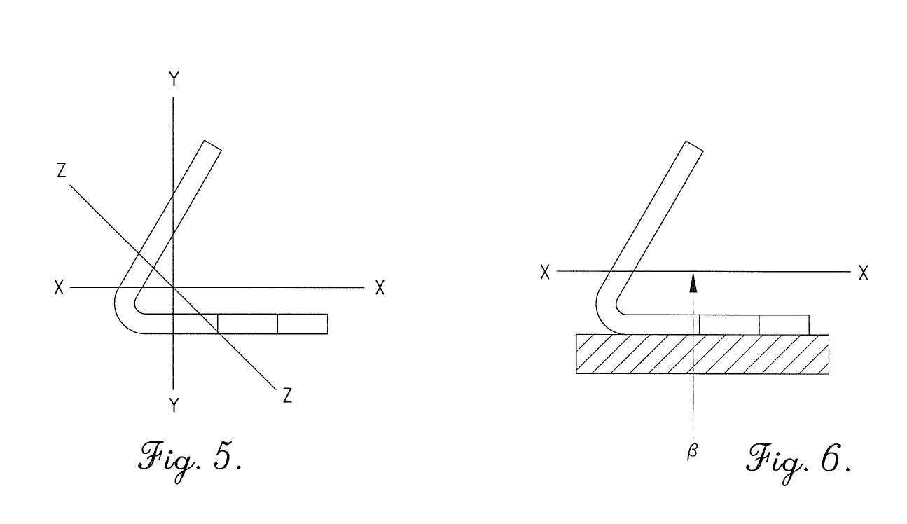

Applicant has discovered that the truss-type support systems 28 can withstand higher compressive loads without excessive bending when the braces 30 are formed with legs separated by an angle less than 90°, and preferably by an angle between 40°-70°. An exemplary embodiment of the truss-type support system 28 takes advantage of this discovery by incorporating braces 30 having legs separated by an angle of approximately 60° as best illustrated in FIGS. 5 and 6. When the truss-type support systems 28 are constructed in this manner, the braces 30 tend to bend away from their mounting surfaces in a direction denoted by the line B in FIG. 6 about an X-axis. This reduces the tendency of the brace legs to bend away from one another and thus prevents any flattening-out of the braces. Moreover, these braces bend less than braces formed from 90° angle iron when subjected to the same load. Thus, the braces 30 more effectively support the conduits 26 and keep the conduits from drooping between the mobile towers 18, 20. The transverse braces 32 may also be constructed in the same manner, with legs separated by 40°-70°.

Applicant has discovered that the truss-type support systems 28 constructed in accordance with the principles of the present invention can support approximately 20% more compressive loading than conventional irrigation system truss-type supports. This permits the truss braces 30 to be made of less metal and/or the truss-type supports 28 to be fabricated with fewer truss braces. In either event, this allows the truss-type support systems 28, and thus the overall irrigation system 10, to be made of less materials and hence be lighter and less costly to manufacture and operate. For example, in one embodiment where the spans 12, 14, 16 are approximately 180′ long and the water conduits 26 are 6⅝″ in diameter, the braces 30 can be formed from 1¾″×1¾″×⅛″ angle iron with 60° legs instead of 2″×2″× 3/16″ angle iron with 90° legs as would be typically required for an irrigation system of this size. The reduction in size of the braces 30 decreases the weight and cost of the irrigation system and increases its efficiency. For example, substituting ⅛″ thick braces for 3/16″ braces in a 180′ span of an irrigation system having 10 total V-shaped supports reduces the weight of the truss-type support by approximately 29%. Alternatively, the truss-type support system may be constructed with fewer braces because of the improved strength of the 60° braces.

A disadvantage of forming the truss braces 30 and transverse braces 32 with 60° angle iron is that they are more difficult to attach to the conduit 26 and the coupling assemblies 40 because the tighter angle between the brace legs leaves less space for a socket or other tool to access the bolts and nuts. Applicants discovered this problem could be rectified, while still benefitting from the improved strength of the 60° angle iron, by flaring or otherwise spreading the legs of the braces 30 near their ends. For example, as best illustrated in FIGS. 2, 7, and 8, each brace 30 and transverse brace 32 may be formed with an intermediate section with legs separated by approximately 60° and ends with legs separated by approximately 70°-90°. The end portions of the braces with 70°-90° separated legs may be between 1″ and 4″ long. This provides more space for tools near the ends of the braces where they are typically attached to other components.

Although the invention has been described with reference to the preferred embodiment illustrated in the attached drawing figures, it is noted that equivalents may be employed and substitutions made herein without departing from the scope of the invention as recited in the claims. For example, unless noted otherwise in the specification, the particular sizes of the irrigation system components described herein may be altered without departing from the scope of the claims.

Having thus described the preferred embodiment of the invention, what is claimed as new and desired to be protected by Letters Patent includes the following:

1. A truss-type support system for a water-carrying conduit of an irrigation system, the truss-type support system comprising:
a plurality of elongated truss braces having first ends attached to the water-carrying conduit; and
at least one truss rod for interconnecting second ends of the truss braces;
the truss braces each having a pair of interconnected legs separated by an angle of approximately 40°-70°.

2. The truss-type support system as set forth in claim 1, wherein the legs of the truss braces are separated by an angle of approximately 60°.

3. The truss-type support system as set forth in claim 1, wherein the truss braces are connected in pairs to form a plurality of V-shaped supports spaced along a length of the water-carrying conduit.

4. The truss-type support system as set forth in claim 3, wherein the V-shaped supports are arranged in pairs on opposite sides of the water-carrying conduit and interconnected by transverse braces.

5. The truss-type support system as set forth in claim 4, wherein the transverse braces each have a pair of interconnected legs separated by an angle of approximately of 40°-70°.

6. The truss-type support system as set forth in claim 5, comprising five pairs of V-shaped supports interconnected by five transverse braces and two truss rods.

7. The truss-type support system as set forth in claim 1, wherein the legs of each of the truss braces are 1¾″-2″ wide and ⅛″- 3/16″ thick.

8. The truss-type support system as set forth in claim 5, wherein the legs of each of the transverse braces are 1¾″-2″ wide and ⅛″- 3/16″ thick.

9. The truss-type support system as set forth in claim 1, wherein the first and second ends of the braces have legs separated by an angle of approximately 90° and intermediate sections of the braces have legs separated by an angle of approximately 60°.

10. An irrigation system comprising:
a plurality of interconnected spans; and
a plurality of mobile towers for supporting the spans above an area to be irrigated;
each of the spans comprising—
a water-carrying conduit;
a plurality of elongated truss braces having first ends attached to the water-carrying conduit, the truss braces each having a pair of interconnected legs separated by an angle of approximately 40°-70°; and
at least one truss rod for interconnecting second ends of the truss braces.

11. The irrigation system as set forth in claim 10, wherein the legs of the truss braces are separated by an angle of approximately 60°.

12. The irrigation system as set forth in claim 10, wherein the truss braces are connected in pairs to form a plurality of V-shaped supports spaced along a length of the water-carrying conduit.

13. The irrigation system as set forth in claim 12, wherein the V-shaped supports are arranged in pairs on opposite sides of the water-carrying conduit and interconnected by transverse braces.

14. The irrigation system as set forth in claim 13, wherein the transverse braces each have a pair of interconnected legs separated by an angle of approximately of 40°-70°.

15. The irrigation system as set forth in claim 14, comprising five pairs of V-shaped supports interconnected by five transverse braces and two truss rods.

16. The irrigation system as set forth in claim 10, wherein the legs of each of the truss braces are 1¾″-2″ wide and ⅛″- 3/16″ thick.

17. The irrigation system as set forth in claim 14, wherein the legs of each of the transverse braces are 1¾″-2″ wide and ⅛″- 3/16″ thick.

18. The irrigation system as set forth in claim 10, wherein the first and second ends of the braces have legs separated by an angle of approximately 90° and portions of the braces intermediate the first and second ends have legs separated by an angle of approximately 60°.

19. The irrigation system as set forth in claim 10, further comprising a stationary pivot connected to a source of fluid for providing fluid to the water-carrying conduit.

20. The irrigation system as set forth in claim 10, wherein the spans are pivotally coupled at one end to the stationary pivot.
